(19) United States
(12) Patent Application Publication
(10) Pub. No.: US 2025/0383717 A1
(43) Pub. Date: Dec. 18, 2025

(54) ACTIVATION OF GESTURE CONTROL FOR HAND-WEARABLE DEVICE

(71) Applicant: Samsung Electronics Co., Ltd., Suwon-si (KR)

(72) Inventors: Sean Bornheimer, Orinda, CA (US); James Michael Wiggins, Pleasant Hill, CA (US); Zainul Shah, San Francisco, CA (US); Emily Malin, San Francisco, CA (US); Sang-Il Park, Suwon (KR); Myungjung Lee, Suwon (KR)

(21) Appl. No.: 19/225,715

(22) Filed: Jun. 2, 2025

Related U.S. Application Data
(60) Provisional application No. 63/660,270, filed on Jun. 14, 2024.

(51) Int. Cl. G06F 3/01

(52) U.S. Cl. CPC G06F 3/017; G06F 3/014

(57) ABSTRACT

A method includes obtaining information associated with movement of a hand-wearable device that is worn by a user of an electronic device, information identifying a proximity of the hand-wearable device to the electronic device, and information associated with activity of the electronic device including usage of the electronic device and one or more applications of the electronic device by the user. The method also includes generating embeddings associated with body motion by the user and with the activity of the electronic device using at least some of the information. The method further includes determining whether gesture recognition is to be performed based on the embeddings. In addition, the method includes, in response to determining that gesture recognition is to be performed, identifying a gesture recognition window and initiating gesture recognition in order to identify one or more gestures by the user involving the hand-wearable device during the gesture recognition window.

### CROSS-REFERENCE TO RELATED APPLICATION AND PRIORITY CLAIM

This application claims priority under 35 U.S.C. § 119(e) to U.S. Provisional Patent Application No. 63/660,270 filed on Jun. 14, 2024, which is hereby incorporated by reference in its entirety.

### TECHNICAL FIELD

This disclosure relates generally to gesture control systems and processes. More specifically, this disclosure relates to activation of gesture control for a hand-wearable device.

### BACKGROUND

Smartphones, televisions, computers, and other devices have become ubiquitous in today's society. However, these types of devices are not easy to use in all situations. For example, there can be challenges in using these types of devices in a hands-free manner or in a one-handed manner. Also, these types of devices are often difficult to use while users are wearing gloves or while the users' hands are wet or dirty. In addition, people with motor skill challenges or other conditions may find that these types of devices are difficult to use.

### SUMMARY

This disclosure relates to activation of gesture control for a hand-wearable device.

In a first embodiment, a method includes obtaining, by at least one processing device of an electronic device, (i) information associated with movement of a hand-wearable device that is worn by a user of the electronic device, (ii) information identifying a proximity of the hand-wearable device to the electronic device, and (iii) information associated with activity of the electronic device including usage of the electronic device and one or more applications of the electronic device by the user. The method also includes generating, by the at least one processing device, embeddings associated with body motion by the user and with the activity of the electronic device using at least some of the information. The method further includes determining, by the at least one processing device, whether gesture recognition is to be performed based on the embeddings. In addition, the method includes, in response to determining that gesture recognition is to be performed, (i) identifying, by the at least one processing device, a gesture recognition window and (ii) initiating, by the at least one processing device, gesture recognition in order to identify one or more gestures by the user involving the hand-wearable device during the gesture recognition window.

In a second embodiment, an electronic device includes at least one processing device configured to obtain (i) information associated with movement of a hand-wearable device that is worn by a user of the electronic device, (ii) information identifying a proximity of the hand-wearable device to the electronic device, and (iii) information associated with activity of the electronic device including usage of the electronic device and one or more applications of the electronic device by the user. The at least one processing device is also configured to generate embeddings associated with body motion by the user and with the activity of the electronic device using at least some of the information. The at least one processing device is further configured to determine whether gesture recognition is to be performed based on the embeddings. In addition, the at least one processing device is configured, in response to determining that gesture recognition is to be performed, to (i) identify a gesture recognition window and (ii) initiate gesture recognition in order to identify one or more gestures by the user involving the hand-wearable device during the gesture recognition window.

In a third embodiment, a non-transitory machine readable medium contains instructions that when executed cause at least one processor of an electronic device to obtain (i) information associated with movement of a hand-wearable device that is worn by a user of the electronic device, (ii) information identifying a proximity of the hand-wearable device to the electronic device, and (iii) information associated with activity of the electronic device including usage of the electronic device and one or more applications of the electronic device by the user. The non-transitory machine readable medium also contains instructions that when executed cause the at least one processor to generate embeddings associated with body motion by the user and with the activity of the electronic device using at least some of the information. The non-transitory machine readable medium further contains instructions that when executed cause the at least one processor to determine whether gesture recognition is to be performed based on the embeddings. In addition, the non-transitory machine readable medium contains instructions that when executed cause the at least one processor, in response to determining that gesture recognition is to be performed, to (i) identify a gesture recognition window and (ii) initiate gesture recognition in order to identify one or more gestures by the user involving the hand-wearable device during the gesture recognition window.

Any one or any combination of the following features may be used with the first, second, or third embodiment. The determination of whether gesture recognition is to be performed may include determining whether the electronic device is in a state in which the user is expected to provide input to the electronic device. The determination of whether the electronic device is in the state in which the user is expected to provide input to the electronic device may include using at least one of: one or more parameters related to whether the electronic device is playing media for the user, one or more parameters related to whether the electronic device is rendering and presenting content to the user, one or more parameters related to whether a notification is being presented to the user, and one or more parameters related to at least one activity by an operating system of the electronic device. A determination may be made if the user is within a specified distance of the electronic device based on the proximity of the hand-wearable device to the electronic device, and gesture recognition may not be performed if the user is not within the specified distance of the electronic device. The determination of whether gesture recognition is to be performed based on the embeddings may include analyzing motions by the user to differentiate between an intentional gesture by the user and other movements. The analysis of the motions may include using at least one of: one or more parameters related to whether the user is interacting with a touchscreen of the electronic device, one or more parameters related to whether the user is interacting with the one or more applications of the electronic device, and a classification of hand, finger, or wrist movements made by the user. The classification of the hand, finger, or wrist movements made by the user may include a selected classification from among a plurality of classifications, and the plurality of classifications may include typing, reading, scrolling, watching, and driving. The determination of whether gesture recognition is to be performed based on the embeddings may include using unique hand motion signatures and predefined motion patterns, and the unique hand motion signatures and predefined motion patterns may be based on common interactions of users with electronic devices while performing different gestures with different motions before and after the different gestures. The embeddings associated with the body motion by the user may be based on sensor data from multiple sensors of the hand-wearable device and estimated poses of a hand, finger, or wrist of the user. The embeddings associated with the activity of the electronic device may be based on at least one of: playback of media by the electronic device, content rendering by the electronic device, application launches by the electronic device, notifications provided by the electronic device, and user interactions with the electronic device including an identification of whether the user is typing on the electronic device, holding the electronic device, or using a specific application of the electronic device.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIG. 2 illustrates an example architecture supporting activation of gesture control for a hand-wearable device in accordance with this disclosure;

FIG. 3 illustrates an example method for activation of gesture control for a hand-wearable device in accordance with this disclosure;

FIG. 4 illustrates another example method for activation of gesture control for a hand-wearable device in accordance with this disclosure; and

FIGS. 5A through 8B illustrate example ways in which activation of gesture control for a hand-wearable device can be used in accordance with this disclosure.

### DETAILED DESCRIPTION

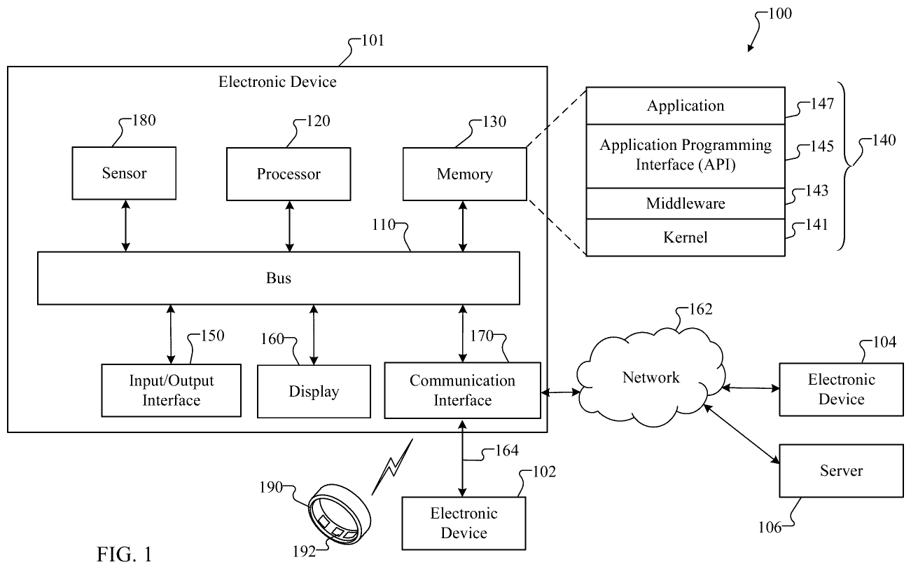

FIGS. 1 through 8B, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, smartphones, televisions, computers, and other devices have become ubiquitous in today's society. However, these types of devices are not easy to use in all situations. For example, there can be challenges in using these types of devices in a hands-free manner or in a one-handed manner. Also, these types of devices are often difficult to use while users are wearing gloves or while the users' hands are wet or dirty. In addition, people with motor skill challenges or other conditions may find that these types of devices are difficult to use.

People often seek out new and simple ways to interact with their devices, including hands-free or one-handed techniques. However, most current approaches rely on cameras or other visual-based systems for things like tap gesture recognition or in-air gesture recognition, and these systems can be rather large and expensive. People also often face challenges in taking quick actions with their devices. However, most current approaches rely on things like adding physical buttons or swipe surfaces to devices or recognizing physical tap gestures on the devices themselves, which can increase device costs or result in falsely-recognized gestures.

Existing smartwatches and virtual reality (VR) headsets enable gesture controls for interacting with device features and other devices. However, smartwatches and VR headsets often lack intuitive and context-sensitive activation (wake-up) mechanisms, such as when users need to awkwardly raise their arms in order to provide gesture inputs. As a particular example of this, some smartwatches require users to raise their arms in order to initiate gesture input and rotate their arms so that the smartwatches are facing the users before users can provide gesture-based inputs, which represents a two-step process (raising the arm and then providing the gesture-based input) that can feel forced and unnatural. Also, smartwatches and VR headsets often present restrictive requirements, such as the need for additional cameras, in order to identify gesture-based controls. In addition, smartwatches and VR headsets may not be as power-constrained as other devices, allowing gesture recognition algorithms to run constantly.

Recently, smart rings worn on the fingers of users and other hand-wearable devices have become available. Smart rings provide an additional avenue for providing gesture-based controls to electronic devices. Small hand and finger gestures can offer a compelling user experience with hand-wearable devices and other emerging devices since humans naturally move their arms, hands, and fingers. However, approaches used for smartwatches and VR headsets are often not tailored to the requirements of smart rings. For example, with smart rings, there is a need to reduce false positives, which refer to mistaking a normal anatomical movement for a gesture. There is also a need to conserve battery life due to a smart ring's diminutive size. In addition, there is a desire to make a user's experience as natural and subtle as possible, such as by avoiding the need for large unnatural movements. Even in circumstances where smart rings have been used to provide gesture-based inputs, those uses are often confined to very specific applications, such as answering a call or stopping a timer, which greatly limits the potential of using smart rings and other hand-wearable devices in daily scenarios.

This disclosure provides various techniques supporting activation of gesture control for hand-wearable devices. For example, as described in more detail below, an electronic device can obtain (i) information associated with movement of a hand-wearable device that is worn by a user of the electronic device, (ii) information identifying a proximity of the hand-wearable device to the electronic device, and (iii) information associated with activity of the electronic device including usage of the electronic device and one or more applications of the electronic device by the user. Embeddings associated with body motion by the user and with the activity of the electronic device can be generated using at least some of the information, and a determination can be made whether gesture recognition is to be performed based on the embeddings. In response to determining that gesture recognition is to be performed, a gesture recognition window can be identified, and gesture recognition can be initiated in order to identify one or more gestures by the user involving the hand-wearable device during the gesture recognition window.

In this way, the described techniques support gesture-based controls involving the use of smart rings or other hand-wearable devices, including those that may be highly power-constrained. Machine learning can be used to understand both body motion context and device context, allowing the use of gesture-based controls in a wide variety of situations. Thus, for example, smart rings and other hand-wearable devices need not be limited to use with gesture-based controls in only very specific use cases. Moreover, improved contextual awareness is useful in obtaining energy efficiency and reducing false positives. For instance, continuously running gesture recognition algorithms on smart rings will typically drain the internal power supplies of the smart rings and create numerous false positives due to the natural hand motions users typically make. The described techniques provide for gesture recognition only when truly needed by differentiating casual motions from intentional interactions (such as by using signal prediction, anomaly detection, and proximity of a hand-wearable device to an electronic device), which can help to conserve power by predicting moments of interaction rather than relying on always-on detection. Further, the described techniques can enable the use of gesture-based controls based on new and more natural (and possibly subtle) gestures involving the smart rings and other hand-wearable devices, which can reduce or eliminate the need to make awkward gestures when wearing smart rings or using other hand-wearable devices. Overall, the described techniques make gesture interactions more accessible, less rigid, and far more versatile for users.

Note that the types of gesture-based controls using smart rings or other hand-wearable devices can vary widely depending on the specific applications in which the smart rings or other hand-wearable devices are used. In the following discussion, it is often assumed that a smart ring is used in conjunction with a smartphone, tablet computer, or other portable electronic device. However, these are for illustration and explanation only and do not limit the techniques provided in this disclosure to use with these specific hand-wearable and electronic devices. Hand-wearable devices may be used to interact with various other types of electronic devices, such as televisions, smart home appliances, or other electronic devices.

Also, in the following discussion, specific examples of gestures are provided, such as sudden fine finger, hand, or wrist movements or combinations thereof. In many or all cases, these gestures may involve specific types of actions that can be performed using one hand of a user, such as taps, rotations, or squeezes. Moreover, gestures can be detected based on a single device (such as a smart ring or other hand-wearable device) or based on multiple devices (such as a smart ring or other hand-wearable device and a smartphone, tablet computer, or other portable electronic device). Among other things, this may allow for the detection of a double-tap or other gesture across multiple devices simultaneously. However, these are for illustration and explanation only and do not limit the techniques provided in this disclosure to use with these specific gestures.

In addition, in the following discussion, specific examples of functions invoked based on gestures are provided, such as opening specific applications, viewing specific notifications/alerts (like those related to incoming calls or text messages), or enabling gestures on the smart rings or other hand-wearable devices themselves. However, these are for illustration and explanation only and do not limit the techniques provided in this disclosure to use with these specific actions. The specific functions that are invoked based on gestures can vary based on a number of factors, including the type of electronic device being controlled using the gestures. Thus, for instance, the specific functions invoked by a smartphone or tablet computer may differ from the specific functions invoked by a television, smart home appliance, or other electronic device.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to activation of gesture control for hand-wearable devices.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform or enable activation of gesture control for hand-wearable devices. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include one or more cameras or other imaging sensors, which may be used to capture images of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to activation of gesture control for hand-wearable devices.

As shown in FIG. 1, the electronic device 101 is able to communicate with at least one hand-wearable device 190, such as via the communication interface 170. In this example, the hand-wearable device 190 represents a smart ring, such as a SAMSUNG GALAXY RING, which can be worn on a finger of a user. The hand-wearable device 190 may include one or more sensors 192, such as one or more sensors for measuring one or more characteristics of the user and/or one or more sensors for measuring one or more characteristics of the hand-wearable device 190 itself. As examples, the hand-wearable device 190 may include a pulse oximeter that measures pulse rate and blood oxygenation level of the user, a photoplethysmography (PPG) sensor that measures heart rate or blood flow of the user, and/or a capacitive touch sensor that measures or detects contact by the user. As other examples, the hand-wearable device 190 may include an accelerometer that measures acceleration of the hand-wearable device 190, a gyroscope that measures orientation of the hand-wearable device 190, and/or a pose estimation sensor that estimates hand/finger/wrist poses. Note, however, that any other or additional sensors may be used, such as a temperature sensor that measures the temperature of the user or a magnetometer that measures magnetic fields.

As described below, one or more of the sensors 192 of the hand-wearable device 190 can be used to sense gestures made by the user with his or her finger, hand, or wrist. For instance, the user may tap his or her thumb and another finger together twice (or other suitable number of times), or the user may tap his or her thumb or another finger on the electronic device 101 itself or on another object (such as a table, a chair, or the ground). Data associated with the tapping may be measured using the sensor(s) 192 of the hand-wearable device 190, and the tapping may be sensed by the electronic device 101 as part of a gesture recognition process.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

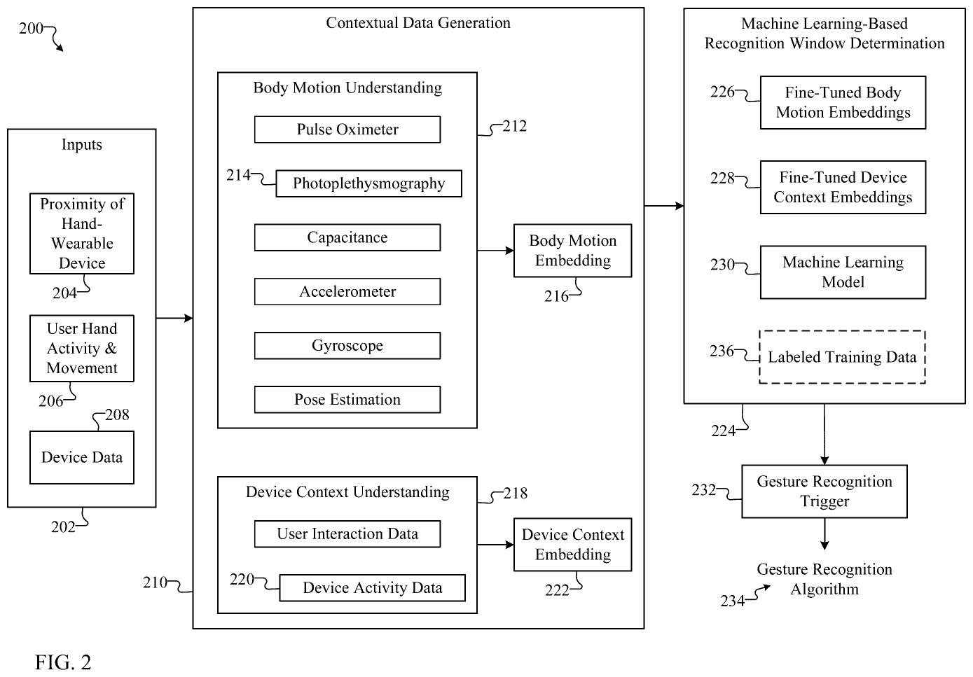

FIG. 2 illustrates an example architecture 200 supporting activation of gesture control for a hand-wearable device in accordance with this disclosure. For ease of explanation, the architecture 200 of FIG. 2 is described as being implemented using the electronic device 101 and the hand-wearable device 190 in the network configuration 100 of FIG. 1. However, the architecture 200 may be implemented using any other suitable device(s) and in any other suitable system(s).

As shown in FIG. 2, the architecture 200 generally operates to receive and process a number of inputs 202. In this example, the inputs 202 include proximity data 204, which indicates the proximity of a hand-wearable device 190 to an electronic device 101. For example, the proximity data 204 may include an estimated distance between the hand-wearable device 190 and the electronic device 101, such as an estimated distance determined based on time-of-flight measurements or other measurements. The proximity data 204 may also include duration information identifying how long the hand-wearable device 190 is within a specified distance of the electronic device 101. The specified distance here can be used to determine whether the hand-wearable device 190 (and therefore the user) is close enough to the electronic device 101 for a long enough period of time so as to be likely to interact with the electronic device 101.

The inputs 202 also include user hand activity and movement data 206, which represents sensor measurements by the hand-wearable device 190 that identify how the hand-wearable device 190 moves while being worn by the user. For instance, the user hand activity and movement data 206 can include data from one or more sensors 192 that measure one or more characteristics of the user (such as pulse oximeter, PPG sensor, and/or capacitive touch sensor measurements) and one or more sensors that measure one or more characteristics of the hand-wearable device 190 itself (such as accelerometer, gyroscope, and/or pose estimation sensor measurements). The user hand activity and movement data 206 can define how the user's hand on which the hand-wearable device 190 is worn moves over time, such as when the user's hand movements vary based on whether the user is typing, reading, scrolling on a device display, watching content, or driving.

The inputs 202 further include device data 208, which represents data related to the user's activities involving the electronic device 101 and activities of the electronic device 101 itself. For example, the device data 208 can include user interaction data and device activity data. The user interaction data can define or relate to how the user is interacting with the electronic device 101, such as whether and to what extent the user is typing, tapping, swiping, touching, or otherwise interacting with a touchscreen or other component of the electronic device 101 (possibly including where the user is contacting the touchscreen, a duration of each contact, and a pressure of each contact), whether and how the user is moving the electronic device 101, and whether and to what extent the user is using one or more applications or other functions of the electronic device 101. The device activity data can define or relate to functions being performed by the electronic device 101, such as whether and how the electronic device 101 is playing media or rendering content, whether the electronic device 101 is receiving an incoming voice communication or text message, and whether the user is interacting with one or more applications of the electronic device 101 and how.

A contextual data generation operation 210 generally operates to process the inputs 202 in order to gain an understanding of contextualized body motion and device activity. In order words, the contextual data generation operation 210 can evaluate the user's body motions (as sensed by the hand-wearable device 190 and optionally the electronic device 101) and activity data related to operation or use of the electronic device 101. Among other things, the contextual data generation operation 210 can be used to detect the proximity of the hand-wearable device 190 to the electronic device 101 and monitor the user's hand activities/movements over time. The contextual data generation operation 210 can also be used to analyze the use of the electronic device 101 and of one or more applications on the electronic device 101 to determine the user's activities over time. In addition, the contextual data generation operation 210 can be used to map the user's body motion context and the device activity context to embeddings, such as via one or more machine learning techniques. The embeddings can be used as described below to determine if and when gesture recognition should be performed.

In this example, the contextual data generation operation 210 includes a body motion understanding function 212, which generally operates to process a variety of different types of data 214 in order to understand the user's body motion context. In this particular example, the different types of data 214 include the data that can be obtained as at least part of the user hand activity and movement data 206. For instance, the different types of data 214 can include measurements of one or more characteristics of the user (such as pulse oximeter, PPG sensor, and/or capacitive touch sensor measurements) and/or measurements of one or more characteristics of the hand-wearable device 190 itself (such as accelerometer, gyroscope, and/or pose estimation sensor measurements). The body motion understanding function 212 may also optionally use the proximity data 204 indicating the proximity of the hand-wearable device 190 to the electronic device 101, such as when the body motion understanding function 212 attempts to understand the user's body motion context only when the hand-wearable device 190 (and therefore the user) is within a threshold distance of the electronic device 101.

The body motion understanding function 212 can make use of the sensor(s) or sensor suite(s) of the hand-wearable device 190 to detect the proximity of the hand-wearable device 190 to the electronic device 101 and understand the user's body motion context through data identifying the user's finger and wrist orientations over time. For example, by employing signal prediction and anomaly detection, the body motion understanding function 212 can accurately differentiate between ordinary user movements and intentional gestures. Thus, for instance, the body motion understanding function 212 can process data defining user body motions over time and generate predictions of what the user's future body motions might be and when the user's actual body motions depart from the predicted body motions (such as by a threshold amount or percentage). In some cases, the body motion understanding function 212 may use a trained machine learning model to predict what the user's future body motions might be based on prior body motions. Once an adequate departure from the predicted body motion (an anomaly) is detected, this can be indicative of the presence of a gesture by the user, so a dynamic gesture algorithm can be triggered as described below. As a particular example of this, the body motion understanding function 212 can be used to distinguish between common user activities (such as typing) and a distinct user gesture (such as the user making a capacitive thumb touch on the hand-wearable device 190 during a double-tap gesture or the user making a rotational gesture by rotating the hand-wearable device 190). This can help to ensure that precise and contextually-appropriate gesture actions are identified based on the user's context.

A body motion embedding function 216 generally operates to process raw motion data and other data, such as from the sensors 192 of the hand-wearable device 190 and optionally from the sensors 180 of the electronic device 101. For example, when the body motion understanding function 212 senses that the user might be making a gesture, the body motion embedding function 216 can generate embeddings using some or all of the different types of data 214 in order to generate embeddings representative of the user's body motions. In some embodiments, the body motion embedding function 216 may be implemented using one or more neural networks or other trained machine learning models, which can be used to convert raw motion data into lower-dimensional, meaningful numerical representations (embeddings) that capture essential characteristics of the user's body movements. The one or more machine learning models may be trained in any suitable manner to generate embeddings for the user's body movements, such as when contrastive learning (an unsupervised learning technique) is used to initialize the machine learning model(s) without using labeled or annotated embedding data.

The contextual data generation operation 210 also includes a device context understanding function 218, which generally operates to process a variety of different types of data 220 in order to understand the device activity context for the electronic device 101. In this example, the different types of data 220 can include the user interaction data and the device activity data, which can represent at least part of the device data 208 described above. For example, the different types of data 220 can include data defining or related to how the user is interacting with the electronic device 101 and data defining or related to functions being performed by the electronic device 101. The device context understanding function 218 may also optionally use the proximity data 204 indicating the proximity of the hand-wearable device 190 to the electronic device 101, such as when the device context understanding function 218 attempts to understand the device context only when the hand-wearable device 190 (and therefore the user) is within the threshold distance of the electronic device 101.

The device context understanding function 218 can interpret the different types of data 220 related to device activity, such as data related to media playback, content rendering, application launches, and notifications, in order to identify the device context. For example, the device context understanding function 218 can use this data 220 to determine whether the electronic device 101 is in a state in which it is likely that the user would provide input via a gesture. Thus, for instance, during media playback or content rendering, the user might provide a gesture to control (such as start, stop, or pause) the media playback or content rendering. When an application is launched, the user might provide a gesture to support two-factor authentication, such as when making a tap gesture on the hand-wearable device 190 or on the electronic device 101 to authenticate the user. When a notification is received, the user might provide a gesture in response to the notification, such as by answering an incoming call or viewing a text message. By coupling device context understanding with an understanding of the user's interactions (like screen touches and application activity), the device context can be used to trigger gesture recognition. Moreover, the device context can be used to ensure that a recognized gesture leads to a specific action that is appropriate given the current state of the electronic device 101, which can help to ensure accurate and contextually-appropriate responses are provided based on the device context.

A device context embedding function 222 generally operates to capture or otherwise obtain and process contextual information from the electronic device 101, such as data indicating whether the user is typing, holding the electronic device 101, or using a specific application or whether the electronic device 101 is receiving a prompt from an application. The device context embedding function 222 converts this contextual information into embeddings that represent the device state and environment associated with the electronic device 101. In some embodiments, the device context embedding function 222 may be implemented using one or more neural networks or other trained machine learning models, which can be used to convert device contextual information into lower-dimensional, meaningful numerical embeddings that capture essential characteristics of the device activity. The one or more machine learning models may be trained in any suitable manner to generate embeddings for the device activities, such as when contrastive learning is used to initialize the machine learning model(s) without using labeled or annotated embedding data.

A machine learning-based recognition window determination operation 224 generally operates to process the embeddings generated by the contextual data generation operation 210 using machine learning in order to determine whether gesture recognition should be performed and (if so) in what window of time the gesture recognition should be performed. In order words, the machine learning-based recognition window determination operation 224 determines if gesture recognition should be performed and when. Among other things, the recognition window determination operation 224 can be used to differentiate between intentional gestures and ordinary movements, interpret user actions (such as typing, reading, scrolling, watching, or driving) to provide context for gesture recognition, and analyze device activity (such as media playback, content rendering, and notifications) to further enhance context and trigger appropriate responses.

In this example, the recognition window determination operation 224 obtains fine-tuned body motion embeddings 226 and fine-tuned device context embeddings 228. The body motion embeddings 226 can represent the embeddings generated by the body motion embedding function 216, and the device context embeddings 228 can represent the embeddings generated by the device context embedding function 222. The embeddings 226, 228 are provided to a machine learning model 230, which processes the embeddings 226, 228 in order to generate predictions as to whether the user is likely to be making a gesture (based on the body motions and device context represented by the embeddings 226, 228). For example, the machine learning model 230 can process sequences of body motion and device context embeddings 226, 228 over time in order to detect or classify potential user gestures over time. This can help to account for the temporal dynamics of gestures, distinguishing between gestures and motions that are similar to the gestures based on their sequence. Among other things, the machine learning model 230 can be used to generate a gesture recognition trigger 232, which represents an indicator that a gesture may be present. The gesture recognition trigger 232 can also identify the time period during which the gesture may have been made. The gesture recognition trigger 232 can be provided to at least one gesture recognition algorithm 234, which may process the embeddings 226, 228 and/or other data in order to identify whether an actual gesture was made by the user and (if so) what that actual gesture was.

The machine learning model 230 represents any suitable machine learning architecture that can process body motion and device context embeddings 226, 228 in order to estimate the presence and timing of user gestures. In some embodiments, for example, the machine learning model 230 may represent or include a long short-term memory (LSTM) sequence classifier, which can be initialized by initial body motion and device context embeddings 226, 228 in a sequence and can process sequences of the body motion and device context embeddings 226, 228 to detect or classify potential user gestures over time. The LSTM sequence classifier can thereby help to account for the temporal dynamics of gestures, distinguishing between similar motions based on their sequence.

The body motion embedding function 216, device context embedding function 222, and LSTM sequence classifier or other machine learning model 230 may be trained in any suitable manner. In this example, labeled training data 236 can be used to train at least these components and optionally other components of the architecture 200. Note that the labeled training data 236 may be used here to train the architecture 200 but need not actually form part of the architecture 200 (particularly after the architecture 200 is trained and deployed to end user devices like the electronic device 101).

In some embodiments, the labeled training data 236 can include labeled examples of user gestures along with corresponding device context data. The labeled training data 236 can therefore serve as or identify ground truths for training the body motion embedding function 216, device context embedding function 222, and machine learning model 230. In some cases, the body motion embedding function 216, device context embedding function 222, and machine learning model 230 can be trained together or in an end-to-end manner in order to recognize patterns specific to gestures to be recognized, thereby reducing false positives. False positives refer to cases in which the architecture 200 identifies that gesture recognition should be performed when no gesture is actually intended.

In order to help reduce false positives, the body motion embedding function 216 may be trained to create embeddings 226 that are highly discriminative, allowing the embeddings 226 to capture subtle differences between various intended gestures (such as tapping a finger or tapping a surface) and everyday motions (such as typing on a keyboard). Also, the device context embedding function 222 may be trained to create embeddings 228 that incorporate contextual cues that can help the architecture 200 differentiate between deliberate gestures and accidental or other user movements. Further, the machine learning model 230 may be trained to leverage the temporal aspect of user gestures, allowing the architecture 200 to recognize a full sequence of movements (such as a series of keyboard strokes) rather than isolated movements. Among other things, the labeled training data 236 can include extensive examples of false positives, which can be based on the form factor and device data of the specific hand-wearable device 190 to be used, allowing the labeled training data 236 to accurately capture false positive information.

The following represents an example workflow that may be used to improve the ability of the architecture 200 to accurately recognize intended gestures while reducing or minimizing the probability of false positives. In a data collection phase, raw biometric/body motion data (such as from IMUs, PPG, and/or other sensors) and device context information can be obtained while one or more users perform various gestures and normal activities (such as keyboard typing, eating, exercising, or swiping on smartphones or tablet computers). The raw data is processed into embeddings 226, 228, such as by using the body motion embedding function 216 and the device context embedding function 222. In some cases, these embeddings 226, 228 can be said to represent unique hand motion signatures and predefined motion patterns. An LSTM sequence classifier or other machine learning model 230 can be trained on the labeled data using those embeddings 226, 228 as inputs to learn the temporal patterns of the various gestures and normal activities. Once trained and deployed for use, the architecture 200 can be used to continuously or otherwise collect data, generate embeddings 226, 228, and use the trained machine learning model 230 to determine if gesture recognition should be performed.

In some cases, to collect user body motion data during the data collection phase, motion data for intended gestures and motion data for common activities may be captured, where the motion data for the common activities can be used to represent false positives. With respect to collecting the motion data for intended gestures, participants may be recruited to perform intended gestures (such as tapping their thumbs, tapping surfaces, or rotating smart rings or other hand-wearable devices 190) in various contexts (such as while standing, walking, sitting, or talking). Data points can be captured by recording accelerometer, gyroscope, magnetometer, PPG, or other data from the hand-wearable devices 190 during each intended gesture.

With respect to collecting the motion data for the common activities, data generated by hand-wearable devices 190 can be collected while participants are engaged in common activities. For example, in the context of typing on physical or virtual keyboards while wearing smart rings or other hand-wearable devices 190, motion data can be recorded while the participants type at different speeds and intensities. In some cases, continuous motion data can be captured in order to identify the characteristic patterns of typing, and keyboard activity data may be captured from the devices to which the participants are providing input via the typing. In the context of eating while wearing smart rings or other hand-wearable devices 190, motion data can be recorded while participants eat using forks, spoons, chopsticks, etc. In some cases, continuous motion data can be captured in order to identify the characteristic patterns of eating. In the contexts of exercising, walking, and running, motion data can be recorded while participants walk, run, or work out on different surfaces and with different equipment. Data can also be collected from devices (such as smart watches or smartphones) indicating the participants' exercise statuses.

To collect device context data during the data collection phase, data generated by hand-wearable devices 190 and/or electronic devices 101 can be collected during common device activities. For example, in the context of participants using smartphones, tablet computers, watches, or other devices, motion data and input data can be recorded while the participants hold and interact with the devices. For example, the data may be recorded while the participants scroll, type, and navigate using these devices. The motion data associated with common device interactions can be recorded. In the context of participants resting their hands, data can be recorded while the participants' hands are at rest or are near rest and in various positions. Baseline motion data when the participants' hand are still may be identified as part of this process.

It is also possible to capture combined body motion and device context data during the data collection phase. For example, data generated by smart rings or other hand-wearable devices 190 and/or electronic devices 101 can be captured when participants are performing gestures while performing common device activities. As examples, in the context of making gestures while moving or exercising, participants can perform intended gestures (such as tapping or rotating the hand-wearable devices 190) while walking or exercising. Data can be recorded to capture the combination of walking/exercising motions and gesture motions, and the walking/exercising motions may be performed at various speeds and on different surfaces. In the context of making gestures while using computers, participants may type on keyboards, make swiping motions on smartphones or tablet computers, or use styluses and then perform intended gestures (such as tapping or rotating the hand-wearable devices 190). Transitions between device usage (such as typing) and performing the intended gestures can be recorded, and motion data can be captured before, during, and after the intended gestures.

All of this information may be preprocessed and used in the manner described above to train the architecture 200. For example, this information may be preprocessed and used to create the labeled training data 236. The labeled training data 236 can be used to train how the body motion embedding function 216 generates the body motion embeddings 226, how the device context embedding function 222 generates the device context embeddings 228, and how the machine learning model 230 generates predictions about whether to perform gesture recognition using the embeddings 226, 228.

Although FIG. 2 illustrates one example of an architecture 200 supporting activation of gesture control for a hand-wearable device, various changes may be made to FIG. 2. For example, various components, operations, or functions in FIG. 2 may be combined, further subdivided, replicated, omitted, or rearranged and additional components, operations, or functions may be added according to particular needs. Also, the specific training techniques provided above are examples only, and any other suitable training techniques may be used to train the architecture 200.

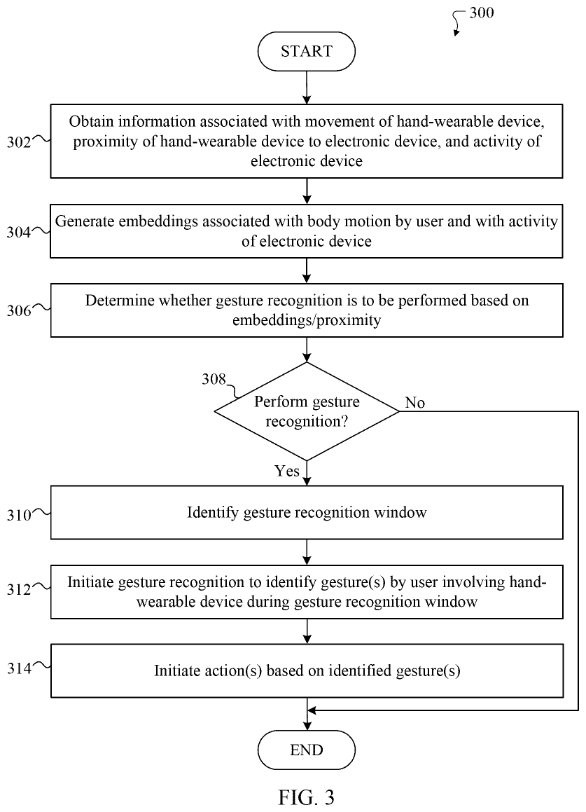

FIG. 3 illustrates an example method 300 for activation of gesture control for a hand-wearable device in accordance with this disclosure. For ease of explanation, the method 300 shown in FIG. 3 is described as being performed using the electronic device 101 in the network configuration 100 shown in FIG. 1, where the electronic device 101 may implement the architecture 200 shown in FIG. 2. However, the method 300 may be performed using any other suitable device(s) and in any other suitable system(s), and the method 300 may be implemented using any other suitable architecture(s) designed in accordance with this disclosure.

As shown in FIG. 3, information associated with movement of a hand-wearable device, proximity of the hand-wearable device to an electronic device, and activity of the electronic device is obtained as step 302. This may include, for example, the processor 120 of the electronic device 101 obtaining various inputs 202, where the inputs include proximity data 204, user hand activity and movement data 206, and device data 208. The proximity data 204 may identify a proximity of the hand-wearable device 190 to the electronic device 101, such as an estimated distance between the hand-wearable device 190 and the electronic device 101 and potentially a duration of time during which the hand-wearable device 190 is within a specified distance of the electronic device 101. The user hand activity and movement data 206 may identify movement of the hand-wearable device 190, which is worn by a user of the electronic device 101, over time. The device data 208 may identify activities of the electronic device 101, such as use of the electronic device 101 and one or more applications of the electronic device 101 by the user over time.

Embeddings associated with body motion by the user and with the activity of the electronic device are generated using at least some of the information at step 304. This may include, for example, the processor 120 of the electronic device 101 performing the contextual data generation operation 210 to generate body motion embeddings 226 using the body motion embedding function 216 and to generate device context embeddings 228 using the device context embedding function 222. In some cases, the embeddings 226 associated with the body motion by the user can be based on sensor data from multiple sensors 192 of the hand-wearable device 190 and/or estimated poses of a hand, finger, or wrist of the user. Also, in some cases, the embeddings associated with the activity of the electronic device 101 can be based on playback of media by the electronic device 101, content rendering by the electronic device 101, application launches by the electronic device 101, notifications provided by the electronic device 101, and/or user interactions with the electronic device 101. The user interactions with the electronic device 101 may include an identification of whether the user is typing on the electronic device 101, holding the electronic device 101, and/or using a specific application of the electronic device 101.

A determination is made whether gesture recognition should be performed based on the embeddings at step 306. This may include, for example, the processor 120 of the electronic device 101 performing the machine learning-based recognition window determination operation 224 to process the embeddings 226, 228 using the machine learning model 230 and determine whether the embeddings 226, 228 are indicative of a potential gesture being performed by the user. In some cases, this may include the recognition window determination operation 224 determining whether the electronic device 101 is in a state in which the user is expected to provide input to the electronic device 101. This determination can be made using various parameters related to whether the electronic device 101 is playing media for the user, rendering and presenting content to the user, presenting a notification to the user, or performing at least one activity using an operating system of the electronic device 101. The parameter(s) related to whether the electronic device 101 is playing media for the user may include the type of media being played (such as audio or video), a duration of the playback, and/or a volume level of the playback. The parameter(s) related to whether the electronic device 101 is rendering and presenting content to the user may include the type of content being displayed (such as text, images, or videos) and/or the specific application being used to render the content. The parameter(s) related to whether the electronic device 101 is presenting a notification to the user may include a classification of detected notifications, such as whether the notifications relate to incoming calls, messages, alerts, or reminders. The parameter(s) related to whether the electronic device 101 is performing at least one activity using an operating system of the electronic device 101 may include a specific activity by the operating system, such as whether background processes are being performed, application management is being used, and/or system notifications are being generated.

Part of the process for determining whether gesture recognition should be performed may be based on the proximity of the hand-wearable device 190 to the electronic device 101. For example, an adequately-small distance between the hand-wearable device 190 and the electronic device 101 (such as a distance less than a specified threshold distance) may indicate that the user is in a location in which the user is more likely to make a gesture in order to interact with the electronic device 101 (as opposed to, for example, being in another room and being unlikely to make a gesture in order to interact with the electronic device 101). The duration or amount of time that the hand-wearable device 190 is within the specified threshold distance may also be used here, such as when the user has remained within the threshold distance of the electronic device 101 for at least a threshold amount of time. If the user is not within an adequate proximity to the electronic device 101 (optionally for at least an adequate amount of time), it may be determined that gesture recognition should not be performed.

In some cases, the determination of whether gesture recognition should be performed based on the embeddings 226, 228 can include using the machine learning model 230 to analyze motions by the user to differentiate between an intentional gesture by the user and other movements. Here, the machine learning model 230 may analyze the user's motions using various parameters related to whether the user is interacting with a touchscreen of the electronic device 101, whether the user is interacting with one or more applications of the electronic device 101, and/or a classification of movements (such as hand, finger, or wrist movements) made by the user. The classification of the user's movements may represent a classification selected by the machine learning model 230 from among multiple classifications, such as classifications that include typing on the electronic device 101, reading content on the electronic device 101, scrolling on the electronic device 101, watching content on the electronic device 101, and driving.

In addition, in some cases, the determination of whether gesture recognition should be performed based on the embeddings 226, 228 can include using unique hand motion signatures and predefined motion patterns. As noted above, the unique hand motion signatures and predefined motion patterns can be based on common interactions of users with electronic devices while performing different gestures with different motions before and after the different gestures. For example, the unique hand motion signatures and predefined motion patterns may relate to specific gestures like tapping fingers, tapping surfaces, or rotating smart rings or other hand-wearable devices 190. The unique hand motion signatures and predefined motion patterns may also relate to specific contexts like standing, walking, sitting, or talking. Thus, for instance, by comparing the embeddings 226, 228 to embeddings of different motions performed during different activities and different gestures, it is possible to determine whether it appears that an intentional gesture is being made.

If a determination is made that gesture recognition should be performed at step 308, a gesture recognition window is identified at step 310. This may include, for example, the processor 120 of the electronic device 101 performing the machine learning-based recognition window determination operation 224 to determine a window or range of time in which it appears a gesture may exist. In some cases, this can include identifying a time period before the possible gesture and a time period after the possible gesture (which may or may not be equal). Also, in some cases, the gesture recognition window may be based on factors such as similarity of the possible gesture to any of the unique hand motion signatures and predefined motion patterns, each of which may span a length of time that defines or affects the length and positioning of the gesture recognition window.

Gesture recognition is initiated in order to identify one or more gestures by the user involving the hand-wearable device during the gesture recognition window at step 312, and one or more actions are performed in response to any identified gesture or gestures at step 314. This may include, for example, the processor 120 of the electronic device 101 performing at least one gesture recognition algorithm 234 in order to identify any likely gestures made by the user. This may also include the processor 120 of the electronic device 101 identifying one or more actions associated with any identified gesture(s) and performing the one or more actions. The one or more actions associated with the identified gesture(s) can be identified in any suitable manner, such as based on the current state of the electronic device 101. Thus, for instance, the processor 120 of the electronic device 101 may open a specific application, open a specific notification or alert (such as by answering an incoming call or viewing a text message), or perform other actions. Also, the specific action(s) performed can vary based on a number of factors, such as whether the electronic device 101 represents a smartphone, tablet computer, television, or smart home appliance and the current state of the electronic device 101.

Although FIG. 3 illustrates one example of a method 300 for activation of gesture control for a hand-wearable device, various changes may be made to FIG. 3. For example, while shown as a series of steps, various steps in FIG. 3 may overlap, occur in parallel, occur in a different order, or occur any number of times (including zero times).

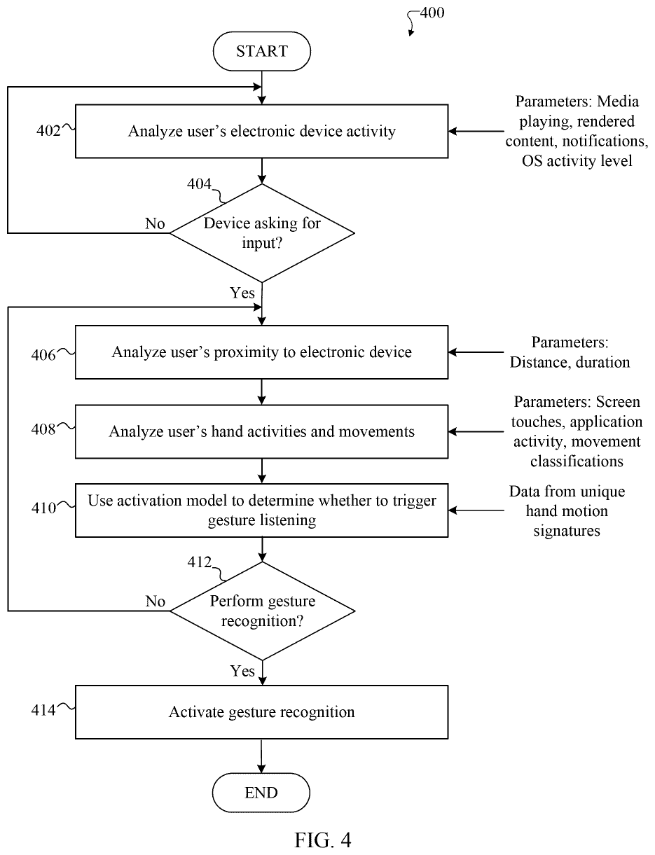

FIG. 4 illustrates another example method 400 for activation of gesture control for a hand-wearable device in accordance with this disclosure. For example, the method 400 may represent a specific implementation of part of the method 300 shown in FIG. 3. For ease of explanation, the method 400 shown in FIG. 4 is described as being performed using the electronic device 101 in the network configuration 100 shown in FIG. 1, where the electronic device 101 may implement the architecture 200 shown in FIG. 2. However, the method 400 may be performed using any other suitable device(s) and in any other suitable system(s), and the method 400 may be implemented using any other suitable architecture(s) designed in accordance with this disclosure.

As shown in FIG. 4, the device activity of a user's electronic device is analyzed at step 402. This may include, for example, the processor 120 of the electronic device 101 analyzing parameters related to whether and how the electronic device 101 is playing media, rendered content, and/or receiving or generating notifications and/or related to an OS activity level of the electronic device 101. Specific example parameters related to these device activities are provided above. Based on this, a determination is made whether the electronic device is asking for input or is otherwise in a state in which input might be provided by the user at step 404. This allows the electronic device 101 to dynamically adjust its behavior based on real-time contextual information. Among other things, this can help to ensure that gesture recognition is only activated when it is genuinely needed, which can help in reducing false positives and in ensuring more accurate and efficient gesture-based interactions.

If a determination is made that the electronic device is not asking for input or that gesture input is otherwise not needed, the process may return to step 402. This allows the electronic device 101 to remain responsive to changes in the user's interactions and the electronic device's state, thereby reducing or minimizing unnecessary gesture inputs and enhancing the user's experience.

If a determination is made that the electronic device is asking for input or that gesture input is otherwise needed, the user's proximity to the electronic device is analyzed at step 406. This may include, for example, the processor 120 of the electronic device 101 analyzing parameters related to the distance of the hand-wearable device 190 (worn by the user) and the electronic device 101, optionally along with a duration of how long the user has been within a specified proximity to the electronic device 101. This allows the electronic device 101 to evaluate the physical distance and potentially how long the user remains near the electronic device 101, thereby helping to ensure relevance to the user's current activity.

The user's hand activities and movements are analyzed at step 408. This may include, for example, the processor 120 of the electronic device 101 continuously or otherwise monitoring the user's hand, finger, and wrist movements in order to distinguish between intentional gestures and regular movements to reduce or minimize false positives. Here, the processor 120 of the electronic device 101 can analyze parameters such as screen touches (how the user interacts with a touchscreen of the electronic device 101), application activity, and hand/finger/wrist movement classifications. Examples of these parameters and movement classifications are provided above.

An activation model is used to determine whether to trigger gesture listening at step 410. This may include, for example, the processor 120 of the electronic device 101 using unique hand motion signatures and predefined motion patterns to determine if gesture recognition should be activated. As noted above, the unique hand motion signatures and predefined motion patterns can be associated with common interactions of users with electronic devices while performing intended gestures, where motion may occur before and/or after the intended gestures. This can enhance the user's experience by helping to ensure that gestures are recognized accurately and promptly.

The results from steps 406-410 can be used to determine whether gesture recognition should be performed at step 412. This may include, for example, the processor 120 of the electronic device 101 determining whether the user is within a specified distance/proximity (and optionally for a specified duration) of the electronic device 101, whether the user's hand activities and movements are indicative of an intentional gesture, and whether the activation model indicates that gesture listening should be triggered. If not, the process may return to step 406 (although the process may return to other steps, such as step 402). Otherwise, gesture recognition can be activated at step 414.

Although FIG. 4 illustrates another example of a method 400 for activation of gesture control for a hand-wearable device, various changes may be made to FIG. 4. For example, while shown as a series of steps, various steps in FIG. 4 may overlap, occur in parallel, occur in a different order, or occur any number of times (including zero times).

Overall, the example processes shown in FIGS. 3 and 4 provide comprehensive techniques for monitoring and evaluating (possibly continuously) a user's proximity, hand activities, and device interactions to determine the need for gesture recognition. By leveraging detailed parameters, these approaches can gain a nuanced understanding of the context in which an electronic device 101 is being used. Moreover, these dynamic and responsive approaches can help to ensure that gesture recognition may only be activated when necessary based on a thorough and continuous analysis of user activity/proximity and device activity, thereby reducing unnecessary activations and improving overall system efficiency.

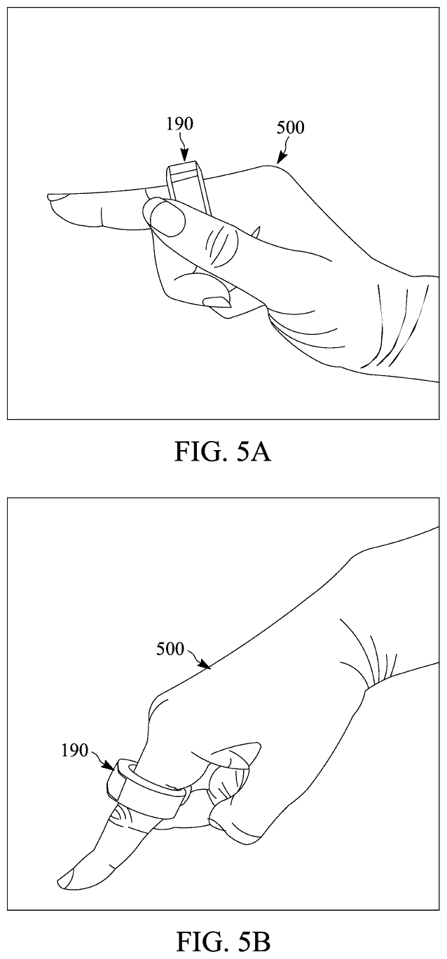

FIGS. 5A through 8B illustrate example ways in which activation of gesture control for a hand-wearable device can be used in accordance with this disclosure. As shown in FIGS. 5A and 5B, a hand-wearable device 190 (namely a smart ring) is worn on the finger of a user's hand 500. To make a specific gesture, the user can extend his or her finger as shown in FIG. 5A and then tap his or her finger on an object as shown in FIG. 5B. By monitoring the user's body motion context and the device context, the electronic device 101 can recognize this as a likely intentional gesture and initiate gesture recognition to confirm the intentional gesture and initiate one or more actions in response.

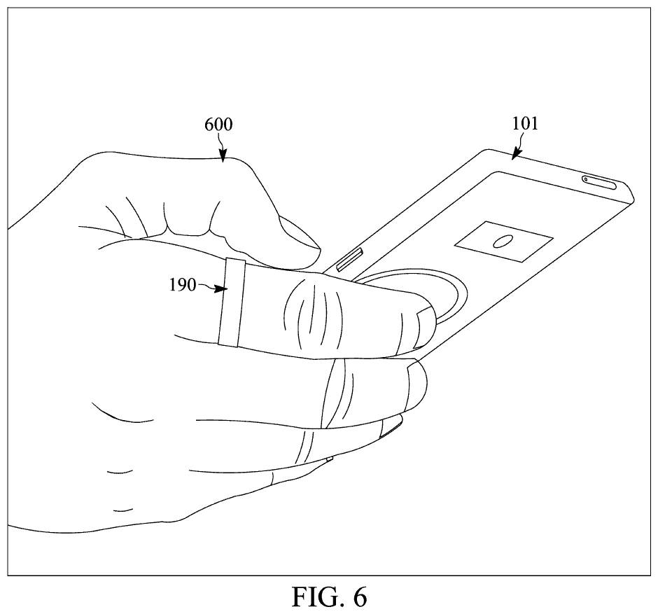

As shown in FIG. 6, a hand-wearable device 190 (namely a smart ring) is worn on the finger of a user's hand 600, and the user is also holding an electronic device 101 in the same hand 600. The electronic device 101 may be in a locked state or other state in which the electronic device 101 can receive user input. The user may double-tap on the electronic device 101 or make some other recognizable gesture, and the electronic device 101 may determine that the double-tap or other gesture is sensed using both the electronic device 101 and the hand-wearable device 190. By determining that the same gesture is recognized using both devices, the electronic device 101 may initiate some function, such as unlocking the electronic device 101. As another example, the user may wish to connect his or her electronic device 101 to another device (such as a vehicle) using a BLUETOOTH connection or other connection. By determining that the same gesture is recognized using both devices, the electronic device 101 may initiate this external connection without additional input. Note that these functions may be accomplished without requiring the user to double-tap a specific location of the electronic device 101.

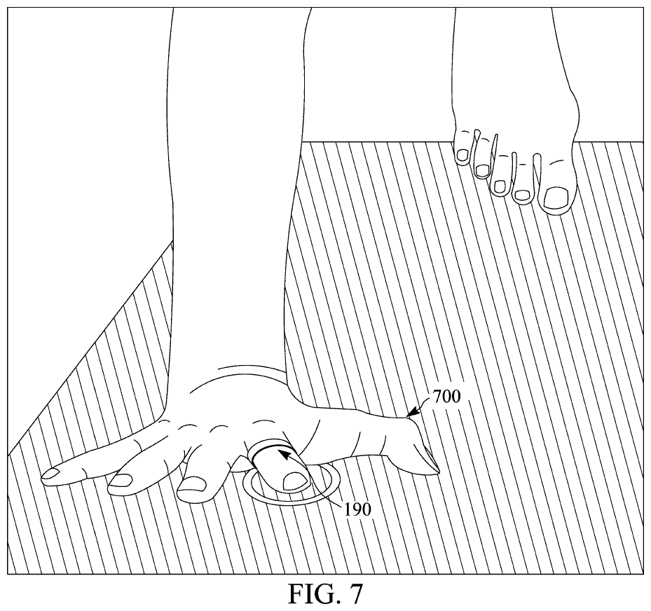

As shown in FIG. 7, a hand-wearable device 190 (namely a smart ring) is worn on the finger of a user's hand 700. The user here is able to use any of a number of surfaces to make a tapping gesture or other gesture involving the hand-wearable device 190. In this example, for instance, the user may be doing yoga and can tap his or her finger on a yoga mat or on the ground one or more times or make some other gesture. The user here is not required to first make an awkward movement (such as raising his or her arm) before making the gesture. Note that the object here is for illustration only and that numerous other objects could be used by the user to make one or more gestures.

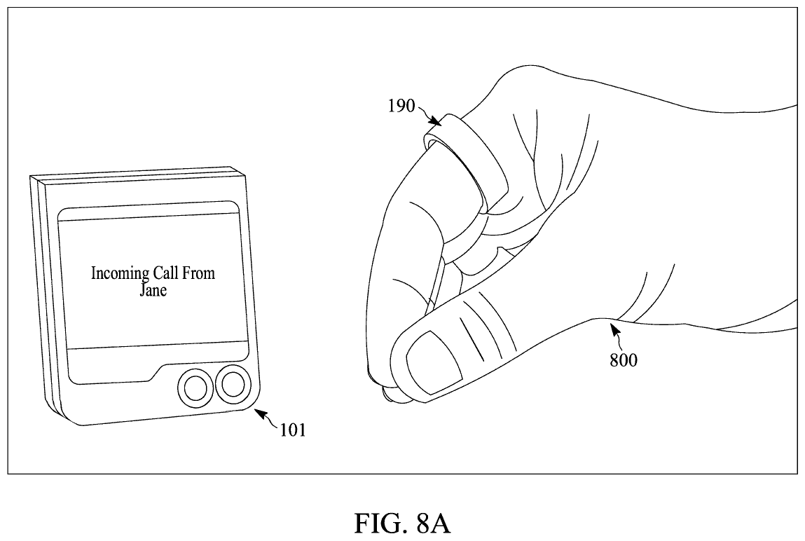

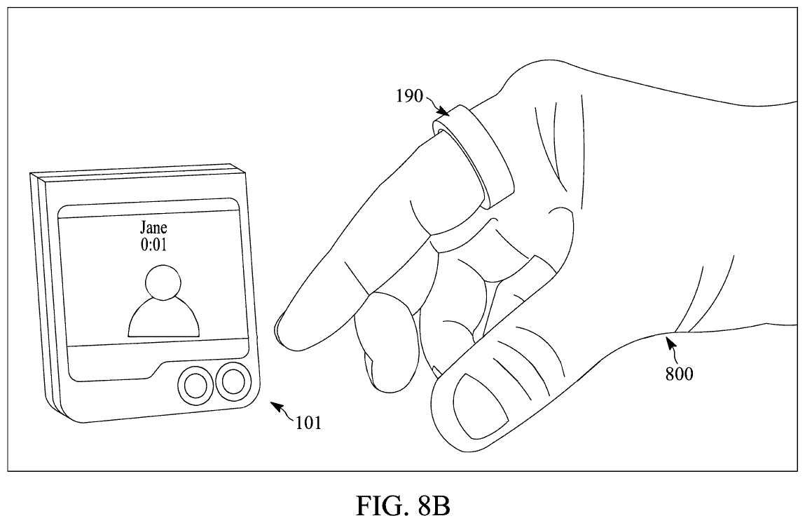

As shown in FIGS. 8A and 8B, a hand-wearable device 190 (namely a smart ring) is worn on the finger of a user's hand 800. The user can make one or more pinching motions, such as by tapping his or her thumb against another finger one or more times. The user's electronic device 101 may detect this gesture and initiate one or more functions, even though the user does not contact the electronic device 101. The one or more functions that are initiated can vary depending on the state of the electronic device 101. In this example, for instance, the electronic device 101 is receiving an incoming call, and the user may make a double-pinch/double-tap gesture to accept the incoming call. However, the user may invoke any other suitable function(s) of the electronic device 101, such as opening an incoming text message, starting or stopping a timer, taking a photograph/starting a countdown for taking a photograph, or dismissing an alarm. The specific function(s) performed can vary depending on the current state of the electronic device 101, which can be captured in the device context embeddings that are generated by the electronic device 101.

Although FIGS. 5A through 8B illustrate examples of ways in which activation of gesture control for a hand-wearable device can be used, various changes may be made to FIGS. 5A through 8B. For example, the specific gestures shown here and the specific actions triggered by the gestures here can easily vary depending on the implementation and on the circumstances.

It should be noted that the functions shown in the figures or described above can be implemented in an electronic device 101, 102, 104, server 106, or other device(s) in any suitable manner. For example, in some embodiments, at least some of the functions shown in the figures or described above can be implemented or supported using one or more software applications or other software instructions that are executed by the processor 120 of the electronic device 101, 102, 104, server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
obtaining, by at least one processing device of an electronic device, (i) information associated with movement of a hand-wearable device that is worn by a user of the electronic device, (ii) information identifying a proximity of the hand-wearable device to the electronic device, and (iii) information associated with activity of the electronic device including usage of the electronic device and one or more applications of the electronic device by the user;
generating, by the at least one processing device, embeddings associated with body motion by the user and with the activity of the electronic device using at least some of the information;
determining, by the at least one processing device, whether gesture recognition is to be performed based on the embeddings; and
in response to determining that gesture recognition is to be performed:
identifying, by the at least one processing device, a gesture recognition window; and
initiating, by the at least one processing device, gesture recognition in order to identify one or more gestures by the user involving the hand-wearable device during the gesture recognition window.

2. The method of claim 1, wherein determining whether gesture recognition is to be performed comprises determining whether the electronic device is in a state in which the user is expected to provide input to the electronic device.

3. The method of claim 2, wherein determining whether the electronic device is in the state in which the user is expected to provide input to the electronic device comprises using at least one of:
one or more parameters related to whether the electronic device is playing media for the user;
one or more parameters related to whether the electronic device is rendering and presenting content to the user;
one or more parameters related to whether a notification is being presented to the user; and
one or more parameters related to at least one activity by an operating system of the electronic device.

4. The method of claim 1, further comprising:
determining if the user is within a specified distance of the electronic device based on the proximity of the hand-wearable device to the electronic device;
wherein gesture recognition is not performed if the user is not within the specified distance of the electronic device.

5. The method of claim 1, wherein:
determining whether gesture recognition is to be performed based on the embeddings comprises analyzing motions by the user to differentiate between an intentional gesture by the user and other movements; and
analyzing the motions comprises using at least one of:
one or more parameters related to whether the user is interacting with a touchscreen of the electronic device;
one or more parameters related to whether the user is interacting with the one or more applications of the electronic device; and
a classification of hand, finger, or wrist movements made by the user.

6. The method of claim 5, wherein the classification of the hand, finger, or wrist movements made by the user comprises a selected classification from among a plurality of classifications, the plurality of classifications including typing, reading, scrolling, watching, and driving.

7. The method of claim 1, wherein determining whether gesture recognition is to be performed based on the embeddings comprises using unique hand motion signatures and predefined motion patterns, the unique hand motion signatures and predefined motion patterns based on common interactions of users with electronic devices while performing different gestures with different motions before and after the different gestures.

8. The method of claim 1, wherein:
the embeddings associated with the body motion by the user are based on sensor data from multiple sensors of the hand-wearable device and estimated poses of a hand, finger, or wrist of the user; and
the embeddings associated with the activity of the electronic device are based on at least one of: playback of media by the electronic device, content rendering by the electronic device, application launches by the electronic device, notifications provided by the electronic device, and user interactions with the electronic device including an identification of whether the user is typing on the electronic device, holding the electronic device, or using a specific application of the electronic device.

9. An electronic device comprising:
at least one processing device configured to:
obtain (i) information associated with movement of a hand-wearable device that is worn by a user of the electronic device, (ii) information identifying a proximity of the hand-wearable device to the electronic device, and (iii) information associated with activity of the electronic device including usage of the electronic device and one or more applications of the electronic device by the user;
generate embeddings associated with body motion by the user and with the activity of the electronic device using at least some of the information;
determine whether gesture recognition is to be performed based on the embeddings; and
in response to determining that gesture recognition is to be performed:
identify a gesture recognition window; and
initiate gesture recognition in order to identify one or more gestures by the user involving the hand-wearable device during the gesture recognition window.

10. The electronic device of claim 9, wherein, to determine whether gesture recognition is to be performed, the at least one processing device is configured to determine whether the electronic device is in a state in which the user is expected to provide input to the electronic device.

11. The electronic device of claim 10, wherein, to determine whether the electronic device is in the state in which the user is expected to provide input to the electronic device, the at least one processing device is configured to use at least one of:
one or more parameters related to whether the electronic device is playing media for the user;
one or more parameters related to whether the electronic device is rendering and presenting content to the user;
one or more parameters related to whether a notification is being presented to the user; and
one or more parameters related to at least one activity by an operating system of the electronic device.

12. The electronic device of claim 9, wherein:
the at least one processing device is further configured to determine if the user is within a specified distance of the electronic device based on the proximity of the hand-wearable device to the electronic device; and
the at least one processing device is configured to not perform gesture recognition if the user is not within the specified distance of the electronic device.

13. The electronic device of claim 9, wherein:
to determine whether gesture recognition is to be performed based on the embeddings, the at least one processing device is configured to analyze motions by the user to differentiate between an intentional gesture by the user and other movements; and
to analyze the motions, the at least one processing device is configured to use at least one of:
one or more parameters related to whether the user is interacting with a touchscreen of the electronic device;
one or more parameters related to whether the user is interacting with the one or more applications of the electronic device; and
a classification of hand, finger, or wrist movements made by the user.

14. The electronic device of claim 13, wherein the classification of the hand, finger, or wrist movements made by the user comprises a selected classification from among a plurality of classifications, the plurality of classifications including typing, reading, scrolling, watching, and driving.

15. The electronic device of claim 9, wherein, to determine whether gesture recognition is to be performed based on the embeddings, the at least one processing device is configured to use unique hand motion signatures and predefined motion patterns, the unique hand motion signatures and predefined motion patterns based on common interactions of users with electronic devices while performing different gestures with different motions before and after the different gestures.

16. The electronic device of claim 9, wherein:
the embeddings associated with the body motion by the user are based on sensor data from multiple sensors of the hand-wearable device and estimated poses of a hand, finger, or wrist of the user; and
the embeddings associated with the activity of the electronic device are based on at least one of: playback of media by the electronic device, content rendering by the electronic device, application launches by the electronic device, notifications provided by the electronic device, and user interactions with the electronic device including an identification of whether the user is typing on the electronic device, holding the electronic device, or using a specific application of the electronic device.

17. A non-transitory machine readable medium containing instructions that when executed cause at least one processor of an electronic device to:
obtain (i) information associated with movement of a hand-wearable device that is worn by a user of the electronic device, (ii) information identifying a proximity of the hand-wearable device to the electronic device, and (iii) information associated with activity of the electronic device including usage of the electronic device and one or more applications of the electronic device by the user;
generate embeddings associated with body motion by the user and with the activity of the electronic device using at least some of the information;
determine whether gesture recognition is to be performed based on the embeddings; and
in response to determining that gesture recognition is to be performed:
identify a gesture recognition window; and
initiate gesture recognition in order to identify one or more gestures by the user involving the hand-wearable device during the gesture recognition window.

18. The non-transitory machine readable medium of claim 17, wherein the instructions that when executed cause the at least one processor to determine whether gesture recognition is to be performed comprise:
instructions that when executed cause the at least one processor to determine whether the electronic device is in a state in which the user is expected to provide input to the electronic device.

19. The non-transitory machine readable medium of claim 17, further containing instructions that when executed cause the at least one processor to determine if the user is within a specified distance of the electronic device based on the proximity of the hand-wearable device to the electronic device;
wherein the instructions when executed cause the at least one processor to not perform gesture recognition if the user is not within the specified distance of the electronic device.

20. The non-transitory machine readable medium of claim 17, wherein:
the instructions that when executed cause the at least one processor to determine whether gesture recognition is to be performed based on the embeddings comprise:
instructions that when executed cause the at least one processor to analyze motions by the user to differentiate between an intentional gesture by the user and other movements; and
the instructions that when executed cause the at least one processor to analyze the motions comprise:
instructions that when executed cause the at least one processor to use at least one of:
one or more parameters related to whether the user is interacting with a touchscreen of the electronic device;
one or more parameters related to whether the user is interacting with the one or more applications of the electronic device; and
a classification of hand, finger, or wrist movements made by the user.
